(19) United States
(12) Patent Application Publication
(10) Pub. No.: US 2024/0207997 A1
(43) Pub. Date: Jun. 27, 2024

(54) LIGHT INTENSITY ADJUSTMENT METHOD FOR OPTICAL FILM THICKNESS MEASURING DEVICE AND POLISHING APPARATUS

(71) Applicant: EBARA CORPORATION, Tokyo (JP)

(72) Inventor: Masaki KINOSHITA, Tokyo (JP)

(21) Appl. No.: 18/541,797

(22) Filed: Dec. 15, 2023

(30) Foreign Application Priority Data
Dec. 27, 2022 (JP) 2022-209855

(51) Int. Cl. B24B 37/013; B24B 37/015

(52) U.S. Cl. CPC B24B 37/013; B24B 37/015

(57) ABSTRACT

A light intensity adjustment method for an optical film thickness measuring device that can improve an operational efficiency of a light source and extend a life of the light source is disclosed. The light intensity adjustment method for an optical film thickness measuring device monitors a light intensity of the light source, and adjusts a voltage applied to the light source based on the monitored light intensity.

### CROSS REFERENCE TO RELATED APPLICATION

This document claims priority to Japanese Patent Application No. 2022-209855 filed Dec. 27, 2022, the entire contents of which are hereby incorporated by reference.

### BACKGROUND

A chemical mechanical polishing (CMP) is a well-known technology in a semiconductor device manufacturing process. A polishing apparatus for performing CMP includes a polishing table that supports a polishing pad and a polishing head for holding a wafer.

When polishing the wafer using the polishing apparatus, the polishing head holds the wafer, and presses the wafer against a polishing surface of the polishing pad at a predetermined pressure. At this time, a relative motion of the polishing table and the polishing head causes the wafer to slide against the polishing surface, and a surface of the wafer is polished.

For example, in order to measure a film thickness of non-metallic films such as silicon oxide film, the polishing apparatus includes an optical film thickness measuring device. The optical film thickness measuring device is configured to direct a light from a light emitter, which consists of a tip of an optical fiber, to the surface of the wafer, and receive a reflected light from the wafer at a light receiver. The polishing apparatus is configured to measure a film thickness of the wafer by analyzing a spectrum of the reflected light.

A light intensity emitted from a light source decreases with the number of light emissions or a light emission time. A rated life of the light source is determined based on such attenuation behavior of the light intensity. However, a tendency of the light intensity attenuation varies depending on individual light sources, and the light intensity may remain sufficiently stable even after the rated life reaches. Generally, the light sources are uniformly replaced according to the reach of their rated life, but in this case, an operational efficiency of light sources is not necessarily good from the viewpoint of achieving a longer life of the light source.

### SUMMARY

Therefore, there are provided a light intensity adjustment method for an optical film thickness measuring device and a polishing apparatus that can improve the operational efficiency of the light source and extend the life of the light source.

Embodiments, which will be described below, relate to a light intensity adjustment method for an optical film thickness measuring device and a polishing apparatus.

In an embodiment, there is provided a light intensity adjustment method for an optical film thickness measuring device, which measures a film thickness of a substrate by irradiating a light onto a surface of the substrate to be polished and receiving the light reflected from the substrate in a polishing apparatus, comprising: monitoring a light intensity of a light source of the optical film thickness measuring device; and adjusting a voltage applied to the light source based on the monitored light intensity.

In an embodiment, comprising: applying a first voltage to the light source when adjusting the voltage to check whether the light intensity of the light source reaches a predetermined intensity; and applying a second voltage to the light source to check whether the light intensity of the light source can be maintained, in a case in which the light intensity of the light source decreases during monitoring the light intensity of the light source.

In an embodiment, comprising, determining an abnormality of the light source, in a case in which a variation value of the light intensity of the light source becomes larger than a predetermined allowable value.

In an embodiment, comprising, determining a time to replace the light source, in a case in which a variation value of the light intensity of the light source changes over time.

In an embodiment, further comprising, heating the light source by a heater attached to the light source before or after starting to use the light source.

In an embodiment, comprising, controlling the heater while monitoring a temperature of the light source based on a signal from a temperature sensor configured to detect the temperature of the light source.

In an embodiment, there is provided a polishing apparatus, comprising: a polishing table configured to support a polishing pad; a polishing head configured to press a substrate against the polishing pad; and an optical film thickness measuring device configured to measure a film thickness of the substrate by irradiating a light onto a surface of the substrate and receiving a light reflected from the substrate, the optical film thickness measuring device comprises a controller configured to measure the film thickness of the substrate based on a signal of the reflected light from the substrate, and the controller is configured to: monitor a light intensity of a light source of the optical film thickness measuring device; and adjust a voltage applied to the light source based on the monitored light intensity.

In an embodiment, the controller is configured to: apply a first voltage to the light source when adjusting the voltage to check whether the light intensity of the light source reaches a predetermined intensity; and apply a second voltage to the light source to check whether the light intensity of the light source can be maintained, in a case in which the light intensity of the light source decreases during monitoring the light intensity of the light source.

In an embodiment, the controller is configured to determine an abnormality of the light source, in a case in which a variation value of the light intensity of the light source becomes larger than a predetermined allowable value.

In an embodiment, the controller is configured to determine a time to replace the light source, in a case in which a variation value of the light intensity of the light source changes over time.

In an embodiment, the light source has a heater for heating a lamp portion.

In an embodiment, the controller is configured to control the heater while monitoring a temperature of the lamp portion based on a signal from a temperature sensor configured to detect the temperature of the lamp portion.

By monitoring the light intensity of the light source and adjusting the voltage applied to the light source based on the monitored light intensity, it is possible to adjust the voltage to account for individual differences in light sources, thereby improving the operational efficiency of the light source. As a result, the life of the film thickness measuring device can be extended.

### BRIEF DESCRIPTION OF THE DRAWINGS

FIG. 1 is a view showing an embodiment of a polishing apparatus;

FIG. 2 is a top view showing a polishing pad and a polishing table;

FIG. 3 is a view showing an optical film thickness measuring device;

FIG. 4 is a graph showing changes over time in a light intensity when a voltage applied to a light source is constant;

FIG. 5 is a view showing a voltage control flow by a controller;

FIG. 6 is a graph showing the light intensity of a light source when the voltage is applied;

FIG. 7 is a graph showing changes over time in the light intensity of the light source when the light source starts emitting light from a cold state;

FIG. 8 is a view showing a heater attached to a lamp portion;

FIG. 9 is a view showing the heater attached to the lamp portion; and

FIG. 10 is a graph showing the light intensity of the light source over time.

### DESCRIPTION OF EMBODIMENTS

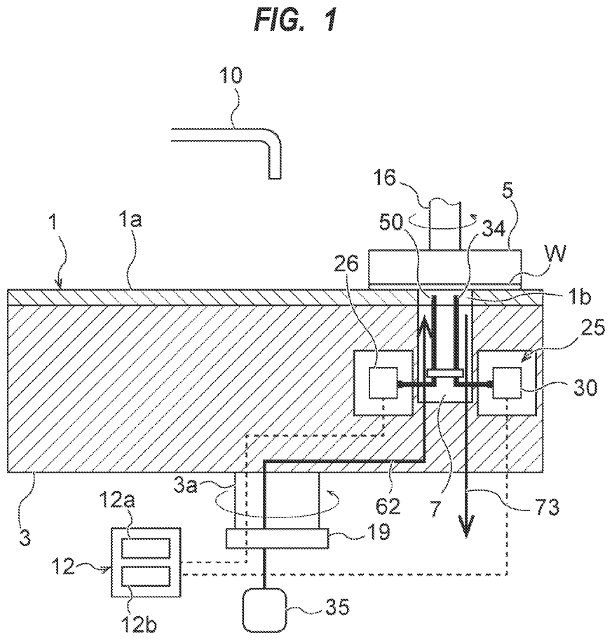

FIG. 1 is a view showing an embodiment of a polishing apparatus. As shown in FIG. 1, the polishing apparatus includes a polishing table 3 that rotates a polishing pad 1 while holding the polishing pad 1, a polishing head (top ring) 5 that presses a wafer W (an example of a substrate) onto the polishing pad 1 to polish the wafer W, and a polishing liquid supply nozzle 10 for supplying the polishing liquid onto the polishing pad 1.

The polishing table 3 is coupled to a table motor 19 arranged below it via a table shaft 3a. The polishing table 3 is rotated by the table motor 19 in a direction shown by an arrow. The polishing pad 1 is attached to an upper surface of the polishing table 3, and the upper surface of the polishing pad 1 constitutes a polishing surface 1a on which the wafer W is polished.

The polishing head 5 is coupled to a lower end of a polishing head shaft 16. The polishing head 5 is configured to hold the wafer W on its lower surface by a vacuum suction. The polishing head shaft 16 is configured to move up and down by a not shown up-and-down movement mechanism.

The polishing of the wafer W is performed as follows. The polishing head 5 and the polishing table 3 are rotated in directions indicated by arrows, respectively, and the polishing liquid is supplied from the polishing liquid supply nozzle 10 onto the polishing pad 1. In this state, the polishing head 5 presses the wafer W onto the polishing surface 1a of the polishing pad 1. The surface of the wafer W is polished by a chemical action of the polishing liquid and a mechanical action of the abrasive grains contained in the polishing liquid.

The polishing apparatus includes an optical film thickness measuring device 25 for measuring a film thickness of the wafer W. Hereinafter, in this specification, the optical film thickness measuring device will be simply referred to as a film thickness measuring device. The film thickness measuring device 25 includes a light source 30 that emits a light, a light emitter (e.g., a light emitting fiber) 34 arranged at a predetermined position in the polishing table 3, a light receiver (e.g., a light receiving fiber) 50 arranged at a predetermined position in the polishing table 3, a spectrometer 26 that decomposes the reflected light from the wafer W according to wavelength and measures an intensity of the reflected light at each wavelength, and a controller 12 that measures the film thickness of the wafer W.

The polishing table 3 has a flow path 7 into which a transparent liquid (e.g., pure water) flows. The light emitter 34 and the light receiver 50 are arranged in the flow path 7 formed in the polishing table 3. The polishing pad 1 has a through hole 1b that is communicated with the flow path 7. The light emitter 34 directs the light to the wafer W on the polishing pad 1 through the through hole 1b, and the light receiver 50 receives the reflected light from the wafer W.

As shown in FIG. 1, the polishing apparatus includes a liquid supply line 62 and a liquid discharge line 73 communicating with the flow path 7, and an on-off valve (not shown) connected to each of the liquid supply line 62 and the liquid discharge line 73. The liquid supply line 62 is connected to the liquid supply source 35.

When the on-off valve is opened during polishing of the wafer W, the liquid supplied from the liquid supply source 35 flows into the flow path 7 (and the through hole 1b) through the liquid supply line 62, and contacts the light emitter 34 and the light receiver 50. The transparent liquid filling a space between the light emitter 34 and the light receiver 50 and the wafer W can prevent the polishing liquid from entering the flow path 7 (and the through hole 1b). The liquid supplied to the flow path 7 (and the through hole 1b) comes into contact with the light emitter 34 and the light receiver 50, and then is discharged from the flow path 7 through the liquid discharge line 73.

As shown in FIG. 1, the controller 12 includes a memory device 12a that stores a program and a processing device 12b that executes operations according to the program. The controller 12, which is composed of a computer, operates according to the program electrically stored in the memory device 12a.

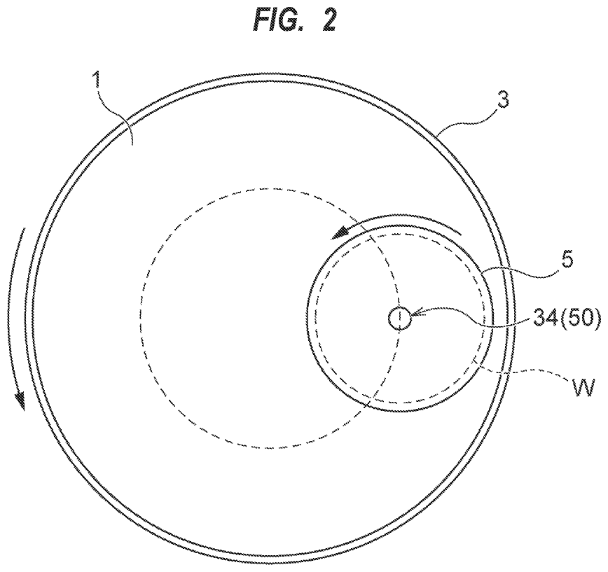

FIG. 2 is a top view showing the polishing pad and the polishing table. The light emitter 34 and the light receiver 50 cross the wafer W each time the polishing table 3 makes one rotation, as shown in a rotation locus (see a dotted line). In the embodiment shown in FIG. 2, a distance between a center of the polishing table 3 and the light emitter 34 and the light receiver 50 is equal to a distance between the center of the polishing table 3 and a center of the polishing head 5. Therefore, the light emitter 34 and the light receiver 50 direct the light to the wafer W and receive the reflected light from the wafer W while crossing the center of the wafer W each time the polishing table 3 makes one rotation.

During polishing of the wafer W, the space between the light emitter 34 and the light receiver 50 and the wafer W is filled with the transparent liquid. With this configuration, the transparent liquid filling the space prevents the polishing liquid from entering the flow path 7 (and the through hole 1b). Furthermore, because the space is filled with the transparent liquid, the light emitted from the light emitter 34 is stably guided to the wafer W, and the light receiver 50 stably receives the reflected light from the wafer W.

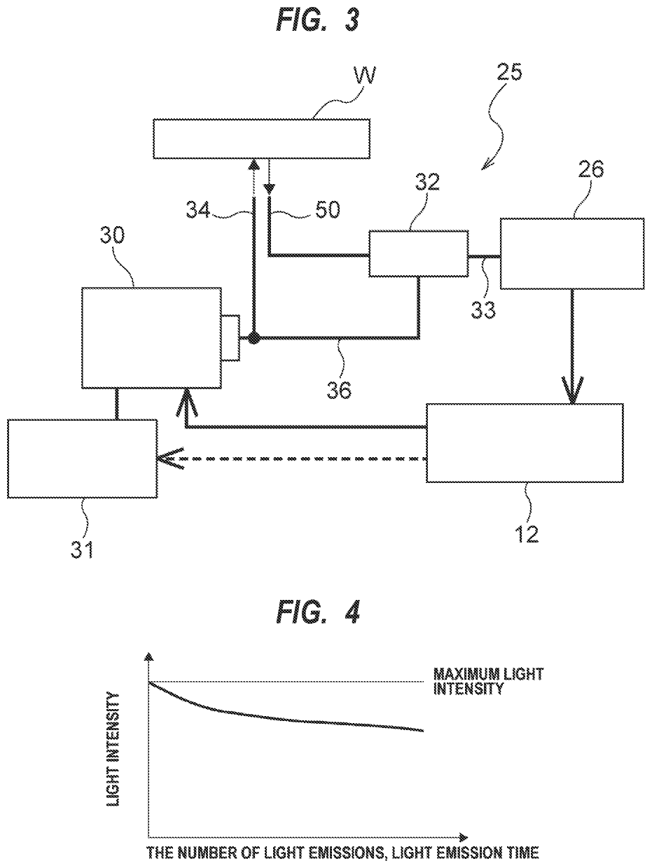

FIG. 3 is a view showing the optical film thickness measuring device. As shown in FIG. 3, the film thickness measuring device 25 includes a light source power supplier 31 connected to the light source 30, and a switcher 32 for selectively sending the light sent from the light source 30 and the light receiver 50 to the spectrometer 26. The spectrometer 26 decomposes the light sent through the switcher 32 according to wavelength, and sends spectrum data of the light to the controller 12.

The controller 12 is configured to determine (measure) the film thickness of the wafer W based on a spectral waveform (spectral data) generated by the spectrometer 26 based on the signal detected by the light receiver 50.

As shown in FIG. 3, the film thickness measuring device 25 includes a monitoring line 36 connected to the light source 30 and the switcher 32. The monitoring line 36 is configured to send the light emitted from the light source 30 directly to the spectrometer 26 through the switcher 32. The light sent to the spectrometer 26 through the monitoring line 36 (and the switcher 32) is decomposed according to wavelength by the spectrometer 26, and the spectral waveform is sent to the controller 12. The controller 12 obtains (measures) a reference intensity of the light (i.e., the monitoring light) emitted from the light source 30 based on the spectral waveform generated by the spectrometer 26.

In one embodiment, the controller 12 irradiates the light from the light emitter 34 toward a mirror, and obtains a reference reflected light by measuring the intensity of the reflected light from the mirror. As another example, the controller 12 may irradiate the light toward a silicon wafer (i.e., a bare wafer) on which no film is formed, and obtain the reference reflected light by measuring the intensity of the reflected light from the silicon wafer.

The memory device 12a stores reference light data corresponding to a reference light and/or reference reflected light data corresponding to the reference reflected light. The reference light data and the reference reflected light data may hereinafter be referred to collectively as reference data. The controller 12 can control a magnitude of the voltage (e.g., discharge voltage) applied to the light source 30.

The controller 12 is configured to monitor a light intensity of the light source 30 and adjust (control) the voltage applied to the light source 30 based on the monitored light intensity in order to accurately measure the film thickness of the wafer W and extend the life of the light source 30.

FIG. 4 is a graph showing changes over time in the light intensity when the voltage applied to the light source is constant. A horizontal axis in FIG. 4 shows the number of light emissions and the light emission time, and a vertical axis shows the light intensity. As shown in FIG. 4, the light intensity decreases with the number of light emissions or with the light emission time elapses. The rated life of the light source is determined based on the behavior of the light intensity attenuation, but a tendency of the light intensity attenuation varies depending on individual differences in the light source, and it is necessary to maintain a sufficiently stable light intensity even after the rated life.

Therefore, if the light source is replaced uniformly according to a reach of the rated life of the light source, the operational efficiency of the light source is not necessarily good from a viewpoint of achieving a longer life of the light source. Therefore, the controller 12 of this embodiment can improve the operational efficiency of the light source by adjusting the voltage in consideration of the individual differences of the light source, and as a result, the life of the light source can be extended. In other words, the light source can be used for a longer period of time.

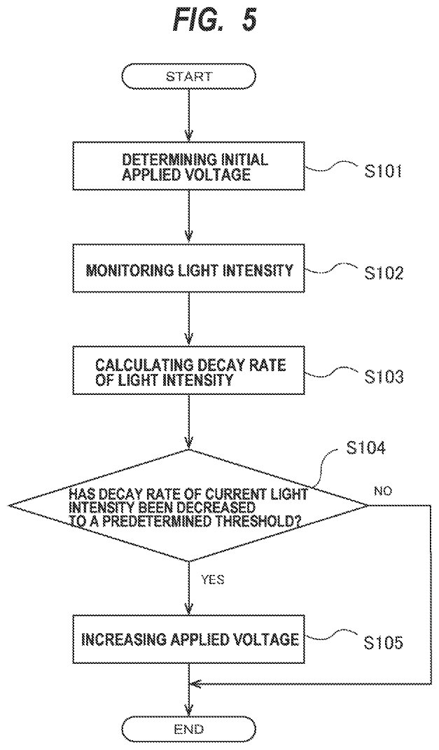

FIG. 5 is a view showing a voltage control flow by the controller. After replacing the light source 30, the controller 12 determines an initial applied voltage (see step S101). A method for determining the initial applied voltage will be described later. At an arbitrary timing while polishing a plurality of wafers W, for example, when the polishing apparatus is on standby, the light intensity of the light source 30 is measured, and the light intensity is monitored (see step S102 in FIG. 5).

The light intensity to be monitored is an output value (light quantity) of the reference light or an output value (light quantity) of the reference reflected light. An arbitrary method can be used to determine the light intensity from the spectral waveform generated by the spectrometer 26. For example, the light intensity can be determined based on the light intensity at an arbitrary wavelength, a peak intensity within an arbitrary wavelength range, or an average value of the light intensity within an arbitrary wavelength range.

The controller 12 calculates a decay rate of the current light intensity based on the initial reference data stored in the memory device 12a and the current light intensity to be monitored (see step S103). The controller 12 then compares the decay rate of the current light intensity with a predetermined threshold value to determine whether the decay rate of the current light intensity has been decreased to a predetermined threshold value (see step S104). The threshold value can be determined corresponding to a minimum light intensity to accurately measure the film thickness of wafer W.

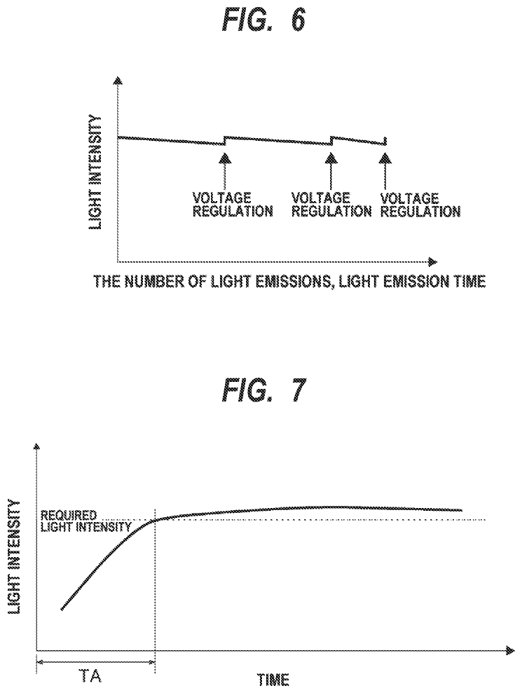

FIG. 6 is a graph showing the light intensity of the light source when the voltage is applied. In FIG. 6, a horizontal axis shows the number of light emissions and the light emission time, and a vertical axis shows the light intensity. When the decay rate of the current light intensity has been decreased to the predetermined threshold value (see “YES” in step S104), as shown in FIG. 6, the controller 12 increases the applied voltage to the light source 30 until the predetermined required light intensity reaches (see step S105). The required light intensity is the light intensity required to accurately measure the film thickness of the wafer W.

If the decay rate of the current light intensity has not been decreased to the predetermined threshold (see “NO” in step S104), the controller 12 terminates a monitoring operation of the light intensity without performing step S105.

When determining an initial value of the voltage applied to the light source 30, the controller 12 determines the initial voltage value based on the light intensity required to measure the film thickness of the wafer W. More specifically, the controller 12 determines the initial voltage value that provides the required light intensity within a range smaller than a maximum value of the applied voltage that realizes a measurement cycle of the wafer W. At this time, the controller 12 obtains a degree of variation of the light intensity of the light source 30.

The film thickness measuring device 25 embedded in the polishing table 3 rotates with the polishing table 3. When rotating the film thickness measuring device 25, the measurement cycle of the wafer W to be polished is determined in advance corresponding to polishing conditions of the wafer W. Such a measurement cycle of the wafer W is stored in the memory device 12a as a control parameter for polishing.

When the light source 30 is a flash light source, a correlation exists between the measurement cycle corresponding to the wafer W to be polished and the voltage applied to the light source 30, and the memory device 12a stores correlation data (first correlation data) indicating the correlation. Basically, as the voltage applied to the light source 30 increases, a maximum frequency at which the light can be emitted decreases. Therefore, in order to shorten the measurement cycle and increase the number of samplings for measuring the film thickness of the wafer W, a voltage lower than the applied voltage that can emit the light with a maximum light emission frequency required for measuring the film thickness of the wafer W is applied. The controller 12 calculates the maximum value of the applied voltage that realizes the measurement cycle of the wafer W based on a first correlation data and the measurement cycle stored in the memory device 12a.

The memory device 12a stores correlation data (second correlation data) indicating the correlation that exists between the applied voltage and the light intensity. As an example of step S104 in FIG. 5, the controller 12 may increase the applied voltage to the light source 30 to obtain a predetermined required light intensity based on the second correlation data. The controller 12 controls the applied voltage to the light source 30 so that the applied voltage does not exceed the maximum value of the applied voltage that realizes the measurement cycle of the wafer W.

In one embodiment, even if the memory device 12a does not store the second correlation data, the controller 12 may be configured to determine the applied voltage by experimentally increasing the voltage gradually to achieve a predetermined light intensity.

In one embodiment, the controller 12 may apply the maximum voltage of the applied voltage that realizes the measurement cycle of the wafer W when adjusting the voltage, measure the output value (light quantity) of the reference light or the output value (light quantity) of the reference reflected light, and adjust the applied voltage to compensate for the attenuation in the light intensity by proportional calculation with the output value (light quantity) of the reference light or the output value (light quantity) of the reference reflected light before adjusting the voltage.

Instead of or in addition to the voltage control flow by the controller 12, the controller 12 may increase the applied voltage based on variations in the light intensity (i.e., the output value of the reference light, the output value of the reference reflected light) of the light source 30. In order to extend the life of the light source 30, it is desirable to decrease the applied voltage as much as possible, the light intensity of the light source 30 may become unstable due to a decrease in the applied voltage, resulting in variations in the light intensity.

Therefore, the controller 12 may monitor the variation in the light intensity of the light source 30 and, if the variation in the light intensity exceeds a predetermined tolerance range, the applied voltage may be adjusted so that the variation in the light intensity falls within the predetermined tolerance range.

According to the embodiment, by adjusting the voltage applied to the light source 30 based on a magnitude and/or a variation of the light intensity obtained by monitoring the light intensity of the light source 30, the magnitude and/or the variation of the light intensity of the light source 30 can be maintained within the tolerance range corresponding to individual differences in the light source 30. Therefore, as a result, a longer life of the light source 30 can be achieved.

The controller 12 may check the operation of the light source 30 by applying a predetermined magnitude of the voltage to the light source 30. More specifically, the controller 12 applies a first voltage (e.g., the rated voltage or the maximum value of the applied voltage that realizes the measurement cycle of the wafer W) to the light source 30 when adjusting the voltage to check (operation check) whether the light intensity of the light source 30 reaches a predetermined intensity (amount). The “predetermined intensity” in the operation check may be the light intensity required to measure the film thickness of the wafer W (required light intensity) or a value determined separately from the required light intensity.

In one embodiment, if the light intensity of the light source 30 does not reach a predetermined intensity during the operation check, the controller 12 may issue an alarm indicating an abnormality of the light source 30.

If the light intensity of the light source 30 reaches a predetermined intensity in the operation check, the controller 12 adjusts the voltage so that the light intensity of the light source 30 reaches a predetermined magnitude (required light intensity) or the variation in the light intensity of the light source 30 falls within a predetermined range, as described above.

In this manner, the controller 12 can adjust the voltage of the light source 30 in two steps. The two steps voltage adjustment allows the controller 12 to determine whether the light source 30 is faulty. As a result, the controller 12 can more reliably measure the film thickness of the wafer W without causing a defect in the measurement of the film thickness of the wafer W caused by a failure of the light source 30.

In one embodiment, the controller 12 may measure the light intensity of the light source 30 (i.e., the output value of the reference light or the output value of the reference reflected light) an arbitrary number of times, and compare the measured variation value of the light intensity with a predetermined tolerance value. For example, the variation value may be calculated from the variation of a peak value of the light intensity within an arbitrary wavelength range, and the predetermined allowable value may be set according to the wafer W to be polished.

The controller 12 determines an abnormality of the light source 30 when the variation value becomes larger than a predetermined allowable value. In this case, the controller 12 may issue an alarm indicating the abnormality of the light source 30.

In one embodiment, the controller 12 determines that a time to replace the light source 30 has been reached when the variation value changes over time. In this case, the controller 12 may issue an alarm indicating an arrival of the time to replace the light source 30.

As described above, by adjusting the voltage applied to the light source 30, the life of the light source 30 can be extended. The light intensity of the light source 30 depends on the magnitude of the voltage applied to the light source 30. Therefore, if a large voltage is applied to the light source 30, the light intensity of the light source 30 increases while the life of the light source 30 is shortened. The life of the light source 30 depends on the magnitude of the applied voltage, and the lower the applied voltage, the longer the life of the light source 30. Therefore, the controller 12 can further extend the life of the light source 30 by optimizing the initial value of the applied voltage after the replacement of the light source 30.

FIG. 7 is a graph showing changes over time in the light intensity of the light source when the light source starts emitting light from a cold state. A horizontal axis in FIG. 7 shows time, and a vertical axis shows the light intensity. As shown in FIG. 7, when the light source 30 starts emitting light while the light source 30 is cold (e.g., when (after) replacing the light source 30, after maintenance of the polishing apparatus, or after the polishing apparatus is on standby for operation), a sufficient light intensity cannot be obtained, and as a result, it takes a long time for the light intensity of the light source 30 to reach the required light intensity (see time TA in FIG. 7).

In general, pre-flash is used to avoid using the light source 30 with insufficient light intensity in this manner. However, in this embodiment, in order to extend the life of the light source 30, the applied voltage is suppressed to the extent that the required light intensity can be obtained. Therefore, a problem of the light intensity decreasing, especially after the light source 30 cools down, becomes more pronounced, and some time is needed before the light intensity of the light source 30 reaches the required light intensity, even if a pre-flash is performed. Furthermore, pre-flash also affects the life of the light source. Therefore, the light source 30 includes a heater. A configuration of the heater is described below with reference to the drawings.

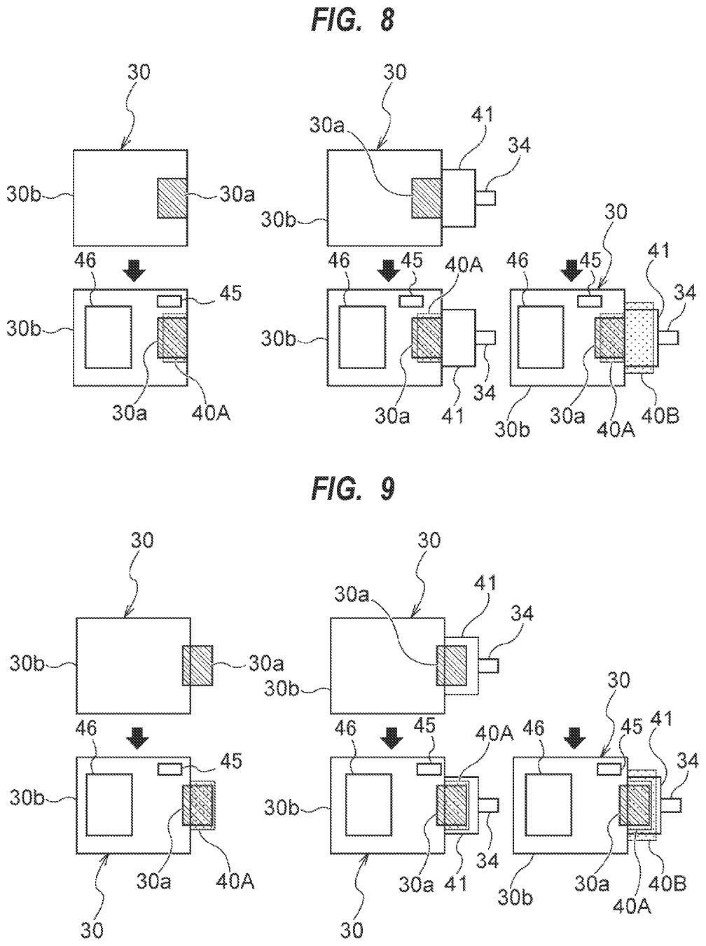

FIGS. 8 and 9 are views showing a heater attached to a lamp portion. As shown in FIG. 8, the light source 30 includes a lamp portion 30a that emits the light, and a housing 30b that accommodates the lamp portion 30a and electrical components. A filled gas is filled in the lamp portion 30a. A heater 40A is attached to the lamp portion 30a, and is configured to heat the lamp portion 30a. More specifically, the lamp portion 30a has a connection surface (not shown) for guiding the light to the light emitter 34, and the heater 40A is attached to the lamp portion 30a excluding this connection surface.

In this specification, a phrase “attached to the lamp portion 30a” includes not only a configuration in which the heater is directly attached to the lamp portion 30a, but also a configuration in which the heater is attached around the lamp portion 30a.

In this embodiment, the heater 40A is a rubber heater attached to the lamp portion 30a, but the heater 40A is not particularly limited as long as it has a structure that heats the lamp portion 30a. For example, the heater 40A may be a nichrome wire wound around the lamp portion 30a, or may be a Peltier element.

As shown in FIG. 8, the light source 30 may include a coupling portion 41 that connects the light emitter 34 and the lamp portion 30a. In this case, the light source 30 may include not only the heater 40A attached to the lamp portion 30a but also a heater 40B attached to the coupling portion 41. The heater 40B indirectly heats the lamp portion 30a by heating the coupling portion 41. The heater 40B may have the same structure as the heater 40A. As shown in FIG. 9, the heater 40A and the heater 40B may be arranged to overlap.

As described above, a configuration in which the heater is attached around the lamp portion 30a is also expressed as “attached to the lamp portion 30a”. Therefore, when the heater 40B heats the coupling portion 41, even in such a configuration, the heater 40B is expressed as “attached to the lamp portion 30a”.

The heater 40A and the heater 40B are electrically connected to the controller 12, and the controller 12 can control operations of the heater 40A and the heater 40B. Therefore, after the polishing apparatus starts operating and before the light source 30 starts emitting light (or starts using it), the controller 12 operates the heater 40A (and the heater 40B) to heat the lamp portion 30a until the light intensity of the light source 30 becomes stable. In other words, when the controller 12 begins to use the light source 30 in its cold state (when it starts emitting light), the controller 12 operates the heater 40A (and the heater 40B) to heat the lamp portion 30a until the light intensity of the light source 30 becomes stable.

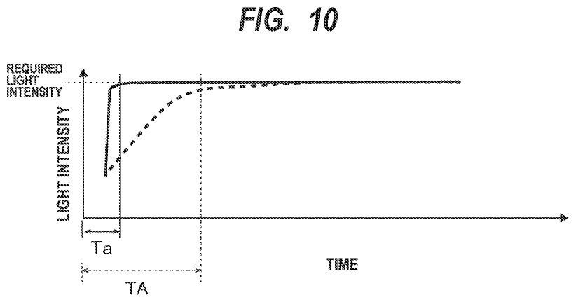

FIG. 10 is a graph showing the light intensity of the light source over time. A horizontal axis in FIG. 10 shows time, and a vertical axis shows the light intensity. As shown in FIG. 10, by heating the lamp portion 30a with the heater 40A (and the heater 40B) before the light source 30 starts emitting light, the light source 30 can obtain sufficient light intensity immediately after its emission, and the light intensity of the light source 30 can reach the required light intensity in a short time (see time Ta in FIG. 10).

As described above, it is usually necessary to warm up operation (i.e., pre-flash) the light source 30 until the light intensity of the light source 30 reaches the required light intensity. Therefore, the polishing of the wafer W cannot be started for the warm up operation time, resulting in a decrease in throughput. According to this embodiment, by heating the lamp portion 30a with the heater 40A (and the heater 40B), the light intensity of the light source 30 reaches the required light intensity in a short time. As a result, a decrease in throughput caused by insufficient light intensity of the light source 30 can be prevented.

In one embodiment, if the light intensity of the light source 30 is not stabilized by heating the lamp portion 30a before the light source 30 starts emitting light, the controller 12 may increase the voltage applied to the light source 30 after the light source 30 is emitted (after the light source 30 starts emitting or is in use) until the light intensity of the light source 30 stabilizes. Thereafter, the controller 12 may perform the control flow shown in the embodiment described with reference to FIG. 5.

In the embodiment described above, the configuration of heating the lamp portion 30a before emitting light from the light source 30 in the cold state is described, but the controller 12 may heat the lamp portion 30a during an idling operation of the polishing apparatus.

In one embodiment, the polishing apparatus may include a temperature sensor 45 that detects the temperature of the lamp portion 30a (see FIGS. 8 and 9). The temperature sensor 45 is electrically connected to the controller 12, and the controller 12 is configured to control the heater 40A (and the heater 40B) while monitoring the temperature of the lamp portion 30a based on a signal detected by the temperature sensor 45.

For example, the controller 12 stops an operation of the heater 40A (and the heater 40B) when the current temperature of the lamp portion 30a increases to a predetermined threshold temperature. For example, the memory device 12a may store a relational equation (curve data) indicating a temperature increasing curve of the lamp portion 30a by the heater 40A (and the heater 40B). The controller 12 may control the operation of the heater 40A (and the heater 40B) so that the temperature of the lamp portion 30a increases along the curve data stored in the memory device 12a.

As shown in FIGS. 8 and 9, the polishing apparatus may include a Peltier element 46 that cools the housing 30b. The Peltier element 46 is electrically connected to the controller 12. While heating the lamp portion 30a is effective to ensure the stability of the light intensity of the light source 30, the heating of the lamp portion 30a may cause damage to precision components housed in the housing 30b. Since the Peltier element 46 is configured to cool the housing 30b, the controller 12 can cool the housing 30b while heating the lamp portion 30a.

In the embodiment described above, the configuration in which the controller 12 monitors the light intensity and adjusts the applied voltage is described, but the monitoring of the light intensity and the adjustment of the applied voltage may be performed by an operator operating the polishing apparatus instead of the controller 12.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A light intensity adjustment method for an optical film thickness measuring device, which measures a film thickness of a substrate by irradiating a light onto a surface of the substrate to be polished and receiving the light reflected from the substrate in a polishing apparatus, comprising:
monitoring a light intensity of a light source of the optical film thickness measuring device; and
adjusting a voltage applied to the light source based on the monitored light intensity.

2. The method according to claim 1, comprising:
applying a first voltage to the light source when adjusting the voltage to check whether the light intensity of the light source reaches a predetermined intensity; and
applying a second voltage to the light source to check whether the light intensity of the light source can be maintained, in a case in which the light intensity of the light source decreases during monitoring the light intensity of the light source.

3. The method according to claim 1, comprising, determining an abnormality of the light source, in a case in which a variation value of the light intensity of the light source becomes larger than a predetermined allowable value.

4. The method according claim 1, comprising, determining a time to replace the light source, in a case in which a variation value of the light intensity of the light source changes over time.

5. The method according to claim 1, further comprising, heating the light source by a heater attached to the light source before or after starting to use the light source.

6. The method according to claim 5, comprising, controlling the heater while monitoring a temperature of the light source based on a signal from a temperature sensor configured to detect the temperature of the light source.

7. A polishing apparatus, comprising:
a polishing table configured to support a polishing pad;
a polishing head configured to press a substrate against the polishing pad; and
an optical film thickness measuring device configured to measure a film thickness of the substrate by irradiating a light onto a surface of the substrate and receiving a light reflected from the substrate,
wherein the optical film thickness measuring device comprises a controller configured to measure the film thickness of the substrate based on a signal of the reflected light from the substrate, and
wherein the controller is configured to:
monitor a light intensity of a light source of the optical film thickness measuring device; and
adjust a voltage applied to the light source based on the monitored light intensity.

8. The polishing apparatus according to claim 7, wherein the controller is configured to:
apply a first voltage to the light source when adjusting the voltage to check whether the light intensity of the light source reaches a predetermined intensity; and
apply a second voltage to the light source to check whether the light intensity of the light source can be maintained, in a case in which the light intensity of the light source decreases during monitoring the light intensity of the light source.

9. The polishing apparatus according to claim 7, wherein the controller is configured to determine an abnormality of the light source, in a case in which a variation value of the light intensity of the light source becomes larger than a predetermined allowable value.

10. The polishing apparatus according to claim 7, wherein the controller is configured to determine a time to replace the light source, in a case in which a variation value of the light intensity of the light source changes over time.

11. The polishing apparatus according to claim 7, wherein the light source has a heater for heating a lamp portion.

12. The polishing apparatus according to claim 11, wherein the controller is configured to control the heater while monitoring a temperature of the lamp portion based on a signal from a temperature sensor configured to detect the temperature of the lamp portion.
